(19) United States
(12) Patent Application Publication
(10) Pub. No.: US 2017/0350356 A1
(43) Pub. Date: Dec. 7, 2017

(54) INJECTOR FOR INJECTING A FLUID, USE OF AN INJECTOR AND METHOD FOR MANUFACTURING AN INJECTOR

(71) Applicant: Robert Bosch GmbH, Stuttgart (DE)

(72) Inventors: Thomas Pauer, Freiberg (DE); Haris Hamedovic, Moeglingen (DE); Karsten Schneider, Bietigheim-Bissingen (DE)

(21) Appl. No.: 15/538,735

(22) PCT Filed: Dec. 15, 2015
(86) PCT No.: PCT/EP2015/079898

§ 371 Date: Jun. 22, 2017

(30) Foreign Application Priority Data
Dec. 22, 2014 (DE) 10 2014 226 811.7

(51) Int. Cl. F02M 51/06; F02M 61/20; C21D 1/613; C21D 9/00

(52) U.S. Cl. CPC F02M 51/061; F02M 61/20; F02M 2200/8053; C21D 1/613; C21D 9/0068; F02M 2200/9061; F02M 2200/08

(57) ABSTRACT

An injector, for injecting a fuel fluid into an intake manifold or into a combustion chamber of a cylinder of an internal combustion engine, includes an electromagnetic actuator that includes a magnetic circuit. The magnetic circuit includes a solenoid, an internal pole, and a magnet armature that cooperates with the solenoid and the internal pole, and is configured to generate a controlled force action between the internal pole and the magnet armature when the electromagnetic actuator is activated with the aid of an activating current and/or an activating voltage. The injector includes a gap in the area between the internal pole and the magnet armature, and includes a valve sleeve that has either paramagnetic material properties in and outside the area of the gap or paramagnetic material properties in the area of the gap and ferromagnetic material properties outside of this area.

### CROSS-REFERENCE TO RELATED APPLICATIONS

The present application is the national stage of International Pat. App. No. PCT/EP2015/079898 filed Dec. 15, 2015, and claims priority under 35 U.S.C. § 119 to DE 10 2014 226 811.7, filed in the Federal Republic of Germany on Dec. 22, 2014, the content of each of which are incorporated herein by reference in their entireties.

### FIELD OF THE INVENTION

The present invention relates to an injector for injecting a fluid, in particular a fuel fluid, into an intake manifold or into a combustion chamber of a cylinder of an internal combustion engine, the injector having an electromagnetic actuator including a magnetic circuit. The present invention also relates to a use of such an injector and a method for manufacturing such an injector.

### BACKGROUND

Electromagnetically actuated injectors of the type mentioned at the outset are usable in general for metering fluids. These injectors are preferably used in fuel systems of internal combustion engines for injecting fuel into a combustion chamber or into an intake manifold (of a cylinder) of the internal combustion engine, the internal combustion engine typically including a plurality of cylinders. Precisely maintaining a predefined injection quantity is crucial for the emission behavior and the consumption behavior of the internal combustion engine. The injected fuel quantity is a function of the opening duration of the valve and thus, in particular, also of an actual hydraulic opening and closing point in time of the valve which may significantly differ from an electrical activation start of the actuator in real valves. Therefore, a precise fluid metering in general cannot take place if only the electrical activation start and end are known. Although it is known in general to carry out the electrical activation of injectors in a controlled manner, the injectors are nowadays typically designed for a purely controlled operation in which an electronic control unit predefines a fixed activation time and the injector responds to it via its magnetic circuit (i.e., opens for the injection of fuel). In this case, the magnetic properties are designed in such a way that the magnetic circuit makes possible preferably short switching times and small tolerances for the injection.

### SUMMARY

It is an object of the present invention to provide an improved injector for injecting a fluid, in particular a fuel fluid, into an intake manifold or into a combustion chamber of a cylinder of an internal combustion engine, the injector being optimized toward a controlled operation. In the case of a controlled operation of the injector, the electromagnetic actuator of the injector is activated in a controlled manner, in particular in a way that is individually adapted to the particular injector. The chronological profile of at least one electrical operating variable of the electromagnetic actuator—in particular during a test activation of the injector which, in an example, is carried out repeatedly—is detected in this case, thus providing information about at least one operating state of the injector and/or about at least one state change of the injector. By detecting at least one feedback signal, different properties of the injection process are detectable, in particular the determination of the opening point in time and/or the closing point in time of the injector. It is therefore an object of the present invention to help improve the feature recognition in the feedback signal so that at least one operating state of the injector and/or at least one state change of the injector is/are better, in particular more precisely or using less signal evaluation effort, detectable based on an analysis of the detected signals or, in particular, of the feedback signal. Based on the feedback of the specific valve behavior (for example the points in time of the valve opening or closing or also of other system functions such as decelerations for the purpose of minimizing noise) the process is controlled toward the setpoint variable, thus increasing the accuracy.

According to the present invention, the injector is designed in such a way that the feedback of the injector—detectable with the aid of the feedback signal or by detecting the chronological profile of at least one electrical operating variable of the electromagnetic actuator—is improved in particular with regard to the current and voltage profiles. A better detection of the opening and closing points in time may then be used to increase the control accuracy, i.e., make it possible in the first place.

The injector according to the present invention, the use of the injector according to the present invention, and the method for manufacturing an injector according to the present invention have the advantage over the related art that an improved feature manifestation in the feedback signal or in the current and voltage signals can be effectuated at the injector for the opening or closing of the injector or the valve needle with the aid of targeted measures. Here, the electromagnetic properties of the injector are given priority. The goal of the measures is, in particular, to preferably increase the portion of the magnetic flux through a gap (i.e., the working air gap) of the valve and/or also to preferably increase the restoring force of the valve spring in order to make possible shorter injection times or shorter opening time intervals of the injector. This means that the injector is not optimized as an independent component—as is the case in the related art—but for the purpose of interacting with the controlled operation or a controlled operating mode. The manifestation of the features (detected signals of the injector or in the feedback signal) which are needed to carry out the control has a pivotal role in this case. The injector is not optimized—as is the case in the related art—with regard to the properties of an independent component, but for the purpose of interacting with the control or the controlled operation. A central aspect represents maximizing the magnetic flux in the gap of the magnetic actuator (working air gap). In this way, the effect of the armature or needle movement on the current and voltage signals is maximized in the form of the kink intensity in the signal. According to the present invention, it is tolerated that individual measures—as contemplated from the point of view of the conventionally used purely controlled operating mode of the injector—initially negatively affect the valve properties (such as the accuracy of the quantity metering). The controlled operation of the injector makes it, however, possible to overall improve the accuracy, reproducibility as well as the lifetime stability of the valve properties.

Against this background, it is provided according to the present invention that the valve sleeve has either continuously—in the area and outside the area of the gap between the internal pole and the magnet armature—paramagnetic material properties, or else has paramagnetic material properties in the area of the gap between the internal pole and the magnet armature and ferromagnetic material properties outside of this area, it being provided according to the present invention that the effort involved in the latter case is comparably small, i.e., a valve sleeve of this type being cost-effectively manufacturable. It is in particular provided that the valve sleeve is designed as a deep-drawn part and continuously has (i.e., essentially over its entire length) paramagnetic material properties and is continuously not annealed, in particular it is not annealed in a temperature range between 350° C. and 700° C. In this way, the valve sleeve is manufacturable particularly cost-effectively, but the magnetic flux in the working air gap (due to the overall paramagnetic properties of the valve sleeve) is still increased or, in any case, not reduced. According to the present invention, it is furthermore in particular preferably provided that the valve sleeve is implemented as a deep-drawn part, the valve sleeve having paramagnetic material properties in the area of the gap between the internal pole and the magnet armature and ferromagnetic material properties outside of this gap area, the valve sleeve being annealed outside of the gap area, in particular annealed in a temperature range between 350° C. and 550° C., the gap area being subjected to a cooling during the annealing process, in particular with the aid of cooled nitrogen. In this way, it is advantageously achieved overall that the valve sleeve is treated in the area of the working air gap—in a comparably cost-effective manner—in such a way that the magnetic resistance is increased there so that the magnetic flux is increased in the area of the working air gap because only a minor portion of the magnetic flux (as a result of the greater magnetic resistance of the material of the valve sleeve) gets lost via the material of the valve sleeve (bypass) and thus does not act in the working air gap.

According to one alternative embodiment of the injector according to the present invention—which can, however, also be advantageously implemented together with the measures for designing the material properties of the valve sleeve—it is provided that the injector includes a valve spring, the spring force of the valve spring being greater than 4 N, in particular greater than 4.5 N. This makes it particularly advantageously possible according to the present invention to preferably precisely meter the fluid quantity or the fuel quantity in the case of one or multiple activation periods of the injector. As a result of a comparably great spring force of the valve spring, it is advantageously possible that a comparably great linear metering range is implementable so that the spring force may be optimally adjusted for the linearity and the accuracy of the fluid quantity or fuel quantity may be ensured by the control.

Advantageous embodiments and refinements of the present invention can be derived from the description with reference to the drawings.

According to one preferred refinement, it is provided that the electromagnetic actuator is activated in a controlled manner by detecting the chronological profile of at least one electrical operating variable of the electromagnetic actuator and thus by obtaining information about at least one operating state of the injector and/or about at least one state change of the injector so that by detecting at least one feedback signal different features of the injection process are detectable, in particular the determination of the opening point in time and/or of the closing point in time of the injector. As a result, it is advantageously possible according to the present invention to increase the accuracy during the operation of the injector overall, although the reproducibility of the injector manufacture is reduced, i.e., the variation with regard to component tolerances is increased, due to individual constructive measures.

Another aspect of the present invention relates to the use of an injector according to the present invention in a method for operating the injector, the electromagnetic actuator being activated in a controlled manner by detecting the chronological profile of at least one electrical operating variable of the electromagnetic actuator—in particular during a test activation of the injector—and thus by obtaining information about at least one operating state of the injector and/or about at least one state change of the injector so that by detecting at least one feedback signal different features of the injection process are detectable, in particular the determination of the opening point in time and/or of the closing point in time of the injector.

This principle according to the present invention makes it possible within the scope of the test activation(s) according to the present invention to particularly precisely establish the occurrence of an operating state or of an operating state change of the injector which requires monitoring. In this way, it is also possible in particular to ascertain an actual hydraulic opening point in time of the valve by predefining appropriate characteristic features.

Another aspect of the present invention relates to a method for manufacturing an injector according to the present invention, the valve sleeve having paramagnetic material properties in the area of the gap between the internal pole and the magnet armature and ferromagnetic material properties outside of this gap area, the valve sleeve being annealed outside of the gap area, in particular annealed in a temperature range between 350° C. and 550° C., the gap area being cooled during the annealing process, in particular with the aid of cooled nitrogen.

It is advantageously possible in this way that the area of the valve sleeve, in which the formation of a ferromagnetic behavior (or a corresponding material property) is prevented, is for the most part limited to the area of the gap (i.e., of the working air gap), for example, on the order of magnitude between 0.5 mm to 3 mm, preferably between 0.8 mm and 1.2 mm, the gap (i.e., the working air gap of the magnetic actuator) being essentially situated in the center with regard to the area in which the formation of a ferromagnetic behavior is prevented.

Additional advantages, features and details are derived from the following description, in which different exemplary embodiments of the present invention are illustrated with reference to the drawing. The features mentioned in the claims and in the description may each be provided either individually or in any combination.

### BRIEF DESCRIPTION OF THE DRAWINGS

FIG. 1 shows a schematic representation of an internal combustion engine having multiple injectors operated according to an example embodiment of the present invention.

FIGS. 2a and 2b show schematic representations of a detailed view of an injector from FIG. 1 in two different operating states, according to an example embodiment of the present invention.

FIG. 3 schematically shows a chronological profile of the different operating variables of the injector operated according to an example embodiment of the present invention.

FIG. 4 schematically shows an example of an injector according to an example embodiment of the present invention.

### DETAILED DESCRIPTION

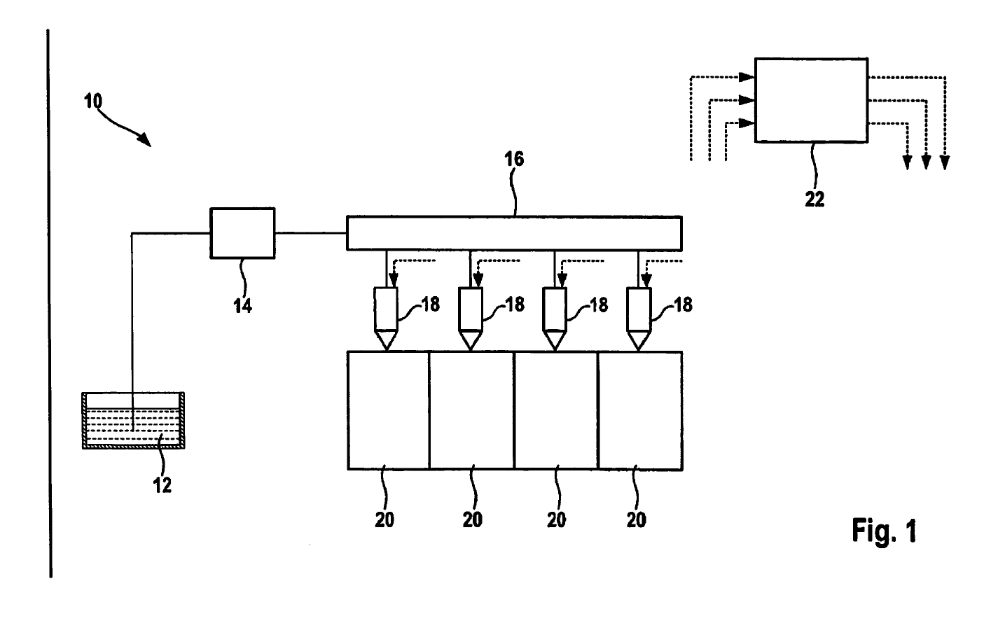

In FIG. 1, an internal combustion engine is identified as a whole by reference numeral 10. It includes a tank 12 out of which a delivery system 14 delivers fuel to a distribution system 16, which is a common rail, for example. Connected to the latter are multiple electromagnetically actuated injectors 18 which inject the fuel directly into combustion chambers 20 assigned to them or also into the intake manifolds of combustion chambers 20. The operation of internal combustion engine 10 is controlled or regulated by a control and regulating system 22, which activates injectors 18, among other things.

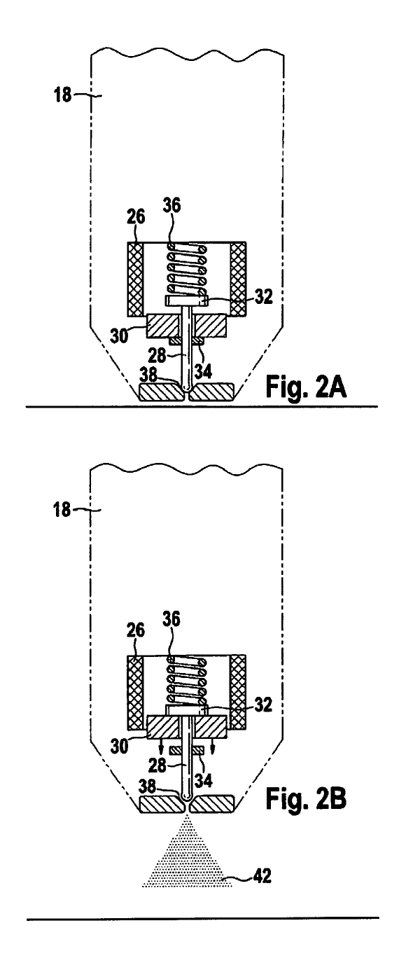

FIGS. 2a and 2b show schematic representations of injector 18 according to FIG. 1 in two different operating states. Injector 18 has an electromagnetic actuator which includes a solenoid 26 and a magnet armature 30 which cooperates with solenoid 26. Magnet armature 30 is operatively connected to a valve needle 28 of injector 18, for example, in such a way that magnet armature 30 is movable relative to valve needle 28 in a non-vanishing mechanical clearance in relation to a vertical direction of movement of valve needle 28 in FIG. 2a. This results, for example, in a two-part mass system 28, 30, which drives valve needle 28 with the aid of electromagnetic actuator 26, 30. This two-part configuration improves the mountability of injector 18 and reduces undesirable rebounding of valve needle 28 when it strikes its valve seat 38. In the present configuration illustrated in FIG. 2a, the axial clearance of magnet armature 30 on valve needle 28 is limited by two stops 32 and 34. As shown in FIG. 2a, a corresponding elastic force against valve seat 38 is applied to valve needle 28 in the area of the housing by a valve spring 36. In FIG. 2a, injector 18 is shown in its closed state in which no fuel injection takes place. In order to effectuate a fuel injection, actuator 26, 30 is acted on by an activating current over a predefinable activation period. Magnet armature 30 is moved upward by this energization of solenoid 26 in FIG. 2b, so that it moves valve needle 28 out of its valve seat 38 against the elastic force by engaging with stop 32. This enables fuel 42 to be injected into combustion chamber 20 (FIG. 1) by injector 18. As soon as the energization of solenoid 26 by control unit 22 (FIG. 1) is terminated at the end of the predefined activation period, valve needle 28 moves back toward its valve seat 38 under the effect of the elastic force applied by valve spring 36, and entrains magnet armature 30. A power transmission from valve needle 28 to magnet armature 30, in turn, takes place with the aid of upper stop 32. When valve needle 28 terminates its closing movement by striking valve seat 38, magnet armature 30 can continue to move downward as a result of the axial clearance in FIG. 2b, until it rests against second stop 34. This corresponds again to the closed state of injector 18 illustrated in FIG. 2a.

According to an example embodiment of the present invention, an operating method is carried out for the purpose of obtaining information about at least one operating state or state change of injector 18. In a first step, at least one test activation is carried out, during which actuator 26, 30 is acted on by a predefinable activating current I. At the same time as the test activation is carried out, at least one chronological profile of at least one electrical operating variable of actuator 26, 30 is preferably detected during the test activation. In the case of electromagnetic actuator 26, 30, a chronological profile of a voltage which is applied at solenoid 26 of the actuator and/or a chronological profile of activating current I which flows through the solenoid is in particular taken into consideration. Subsequently, the detected chronological profiles are evaluated for the presence of a predefinable operating state and/or a predefinable operating state change of a feature characterizing injector 18. A feature in the sense of the present invention can be in particular a local extreme and/or a sequence of multiple local extremes and/or another type of a particular chronological profile of the operating variables current and/or voltage. The characteristic feature of interest is found during the evaluation and the obtained information about the operating state or the operating state change is further used to control a future operation of injector 18, for example. A plurality of test activations is also possible according to the present invention. It is, in particular, advantageously possible according to the present invention to ascertain an actual hydraulic opening point in time of injector 18.

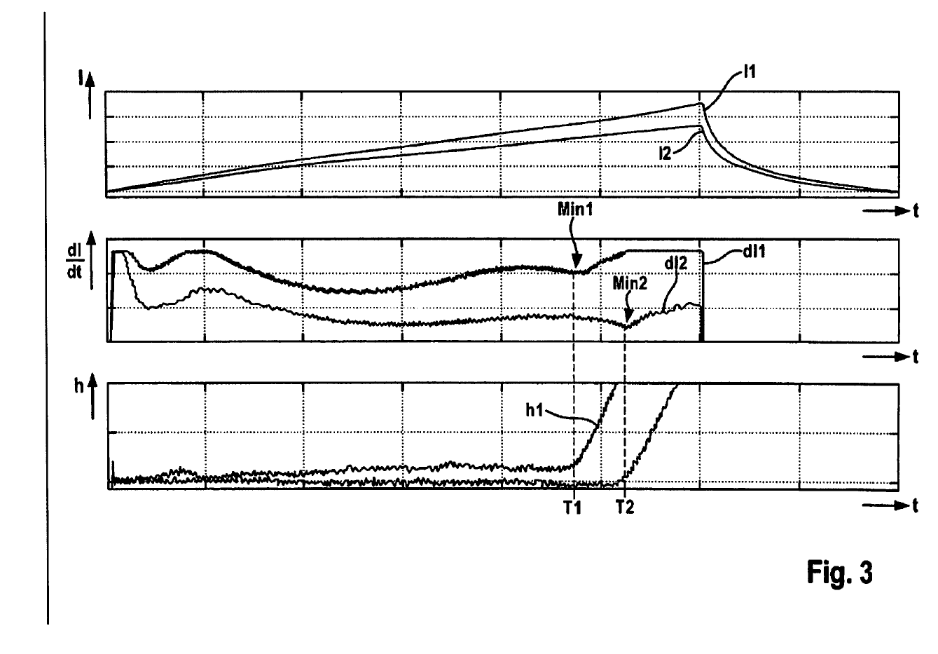

The hydraulic opening point in time of injector 18 is determined by valve needle 28 lifting from its valve seat 38. This lifting of valve needle 28 correlates with a special chronological profile of the first chronological derivation of activating current I through solenoid 26. FIG. 3 shows, in this regard, a first chronological profile I1 of an activating current I which is used to activate solenoid 26—starting from the closed state of valve 18 shown in FIG. 2a—for the purpose of putting injector 18 in its open state. A chronological profile hl of needle lift h resulting during the activation using first activating current I is also illustrated in FIG. 3. After starting to apply activating current I to actuator 26, 30, non-vanishing values for lift profile h1 occur for the first time at point in time T1 (i.e., an operating state change of injector 18 takes place from its closed state toward its open state at point in time T1.) Accordingly, at least the chronological profile I1 of activating current I is detected and first chronological derivation dI1 of previously detected first activating current I is formed during the evaluation. As a result, by knowing ascertained opening point in time T1, it is possible to carry out a subsequent operation of injector 18 in a controlled manner, for example, with regard to an equalization of the injection characteristic of multiple injectors 18. If local minimum Min1 has not been already detected after carrying out the first test activation, it is possible to carry out another test activation, if necessary.

In addition to first activating current I1, FIG. 3 also shows a chronological profile of a second activating current I2 resulting during the activation of actuator 26, 30 using a slightly reduced activating voltage. As is to be expected, the operating state change characterizing the transition from the closed state to the open state takes place in a slightly delayed manner with regard to lift profile h1 which results during the activation using a greater activating voltage. According to the present invention, point in time T2, which, in turn, corresponds to a local minimum Min2 in first chronological derivation dI2 of second activating current I2, may be ascertained for the activation process by using second activating current I2 as the actual hydraulic activation start, i.e., opening point in time.

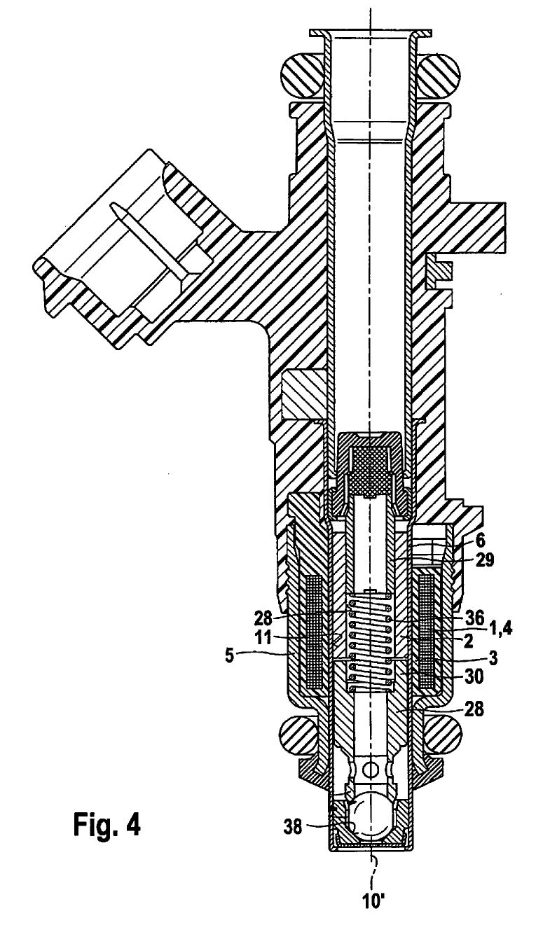

In FIG. 4, an electromagnetically actuatable injector 18 is illustrated by way of example in the form of a fuel injector for fuel injection systems, for example, for the use in mixture-compressing, spark ignition internal combustion engines. Injector 18 includes a, for the most part, tubular core 2 which is surrounded by a solenoid 1 and which is used as the internal pole and partially as the fuel through-flow. Solenoid 1 is completely surrounded in the circumferential direction by an external, sleeve-shaped ferromagnetic valve jacket 5, for example, which is designed in a stepped manner and which represents an external component of the magnetic circuit serving as an external pole. Solenoid 1, core 2, and valve jacket 5 together form an electrically excitable operating element or a magnetic circuit or an electromagnetic actuator. While a winding 4 of solenoid 1, the latter being embedded in a coil body 3, surrounds a valve sleeve 6 from the outside, core 2 is inserted in an internal opening 11 of valve sleeve 6 which runs concentrically to a valve longitudinal axis 10′. Valve sleeve 6 is elongated and thin-walled. Opening 11 serves, among other things, as the guiding opening for a valve needle 28 which is axially movable along valve longitudinal axis 10′. Valve sleeve 6 extends in the axial direction over approximately half of the axial overall extension of the injector, for example. In the example of FIG. 4, valve needle 28 is connected in one piece to magnet armature 30 and is formed from tubular magnet armature 30, a likewise tubular needle section, and a spherical valve closing body. The injector is actuated electromagnetically in a manner known per se.

The electromagnetic circuit including solenoid 1, internal core 2, external valve jacket 5, and magnet armature 30 is used for axially moving valve needle 14 and thus for opening the injector against the spring force of restoring spring 36 acting on valve needle 28 and for closing the injector. Magnet armature 30 is oriented toward core 2. Instead of core 2, a cover part, which closes the magnetic circuit, can also be provided as the internal pole, for example.

Apart from restoring spring 36, an adjusting element in the form of an adjusting sleeve 29 is inserted into a flow bore 28 of core 2 which runs concentrically to valve longitudinal axis 10′ and which is used to supply the fuel in the direction of valve seat area 38. Adjusting sleeve 29 is used to adjust the spring preload of restoring spring 36 which is applied to adjusting sleeve 29 and which, in turn, is supported at its opposite side on valve needle 28 in the area of magnet armature 30.

According to the present invention, valve sleeve 6 continuously has either—in and outside the area of the gap between internal pole 2 and magnet armature 30—paramagnetic material properties, or else has paramagnetic material properties in the area of the gap between internal pole 2 and magnet armature 30 and ferromagnetic material properties outside of this area. According to the first alternative (paramagnetic material properties in and outside the area of the gap between internal pole 2 and magnet armature 30), it is preferably provided that valve sleeve 6 is implemented as a deep-drawn part, valve sleeve 6 continuously having paramagnetic material properties and continuously being not annealed, in particular not annealed in a temperature range between 350° C. and 550° C. According to the second alternative (paramagnetic material properties in the area of the gap between internal pole 2 and magnet armature 30 and ferromagnetic material properties outside of this area), it is preferably provided that valve sleeve 6 is implemented as a deep-drawn part, valve sleeve 6 having paramagnetic material properties in the area of the gap between internal pole 2 and magnet armature 30 and ferromagnetic material properties outside of this gap area, valve sleeve 6 being annealed outside of the gap area, in particular annealed in a temperature range between 350° C. and 550° C., the gap area being subjected to a cooling during the annealing process, in particular with the aid of cooled nitrogen.

Alternatively or additionally to these measures, it is provided according to the present invention that injector 18 includes a valve spring 36, the spring force of valve spring 36 being greater than 4 N, in particular greater than 4.5 N.

In this way, the control quality of the injector can be improved overall by combining certain properties of the magnetic circuit and a control function, so that a control function for injecting a fluid through the injector is implementable. The pot surrounding the solenoid and the sleeve of the magnetic circuit together with its magnetic resistance Rₘ are in particular significant features according to the present invention for manifestation in the feedback signal of the injector. In conventionally used injectors which are based on the purely controlled operating mode, these components are typically annealed for the purpose of obtaining a reduced magnetic resistance Rₘ. According to an example embodiment of the present invention, an annealed operation of this type is avoided during the manufacture of the injector, thus improving the manifestation of the feature for control and detectability of the feature for the control.

1-7. (canceled)

8. An injector for injecting a fluid into an intake manifold or into a combustion chamber of a cylinder of an internal combustion engine, the injector comprising:
an electromagnetic actuator including a magnetic circuit, wherein:
the magnetic circuit includes a solenoid, an internal pole, and a magnet armature that cooperates with the solenoid and the internal pole; and
the magnetic circuit is configured to generate a controlled force action between the internal pole and the magnet armature when the electromagnetic actuator is activated with at least one of an activating current and an activating voltage; and
a valve sleeve that has (a) paramagnetic material properties in an area of a gap between the internal pole and the magnet armature and (b) either the paramagnetic material properties or ferromagnetic material properties outside of the area of the gap.

9. The injector of claim 8, wherein the valve sleeve is implemented as a deep-drawn part having the paramagnetic material properties throughout its entirety and none of which is annealed.

10. The injector of claim 8, wherein the valve sleeve is implemented as a deep-drawn part having the paramagnetic material properties throughout its entirety and none of which is annealed in a temperature range between 350° C. and 700° C.

11. The injector of claim 8, wherein the valve sleeve:
is implemented as a deep-drawn part having the paramagnetic material properties in the area of the gap and the ferromagnetic material properties outside of the area of the gap; and
is formed by a process that includes annealing outside of the area of the gap while the gap is subjected to a cooling.

12. The injector of claim 11, wherein the annealing is in a temperature range between 350° C. and 700° C.

13. The injector of claim 11, wherein the cooling is with cooled nitrogen.

14. The injector of claim 8, further comprising a valve spring (36) with a spring force of greater than 4 N.

15. The injector of claim 8, further comprising a valve spring (36) with a spring force of greater than 4.5 N.

16. The injector of claim 8, wherein the electromagnetic actuator is activated in a controlled manner based on information about at least one of (a) at least one operating state of the injector and (b) at least one state change of the injector determined by:
obtaining a feedback signal;
detecting a chronological profile of at least one electrical operating variable of the electromagnetic actuator based on the feedback signal; and
obtaining the information based on the detected chronological profile.

17. The injector of claim 16, wherein the electromagnetic actuator is activated in the controlled manner based on the information about the at least one state change of the injector, the information being at least one of an opening point in time of the injector and a closing point in time of the injector.

18. The injector of claim 8, wherein the injector is configured to injecting a fuel fluid.

19. A method comprising:
obtaining, by processing circuity, a feedback signal;
detecting, by the processing circuitry, a chronological profile of at least one electrical operating variable of an electromagnetic actuator based on the feedback signal;
based on the detected chronological profile, determining, by the processing circuitry, information about at least one of (a) at least one operating state of an injector and (b) at least one state change of an injector for injecting a fluid into an intake manifold or into a combustion chamber of a cylinder of an internal combustion engine; and
activating, by the processing circuitry, the electromagnetic actuator in a controlled manner based on the information.

20. The method of claim 19, wherein the electromagnetic actuator is activated in the controlled manner based on the information about the at least one state change of the injector, the information being at least one of an opening point in time of the injector and a closing point in time of the injector.

21. The method of claim 19, wherein the detected chronological profile is detected during a test activation of the injector.

22. The method of claim 19, wherein:
the injector includes an electromagnetic actuator that includes a magnetic circuit;
the magnetic circuit includes a solenoid, an internal pole, and a magnet armature that cooperates with the solenoid and the internal pole;
the magnetic circuit is configured to generate a controlled force action between the internal pole and the magnet armature when the electromagnetic actuator is activated with at least one of an activating current and an activating voltage; and
the injector includes a valve sleeve that has (a) paramagnetic material properties in an area of a gap between the internal pole and the magnet armature and (b) either the paramagnetic material properties or ferromagnetic material properties outside of the area of the gap.

23. The method of claim 22, wherein the injector is configured to injecting a fuel fluid.

24. A method for manufacturing an injector for injecting a fluid into an intake manifold or into a combustion chamber of a cylinder of an internal combustion engine, the method comprising:
providing an electromagnetic actuator including a magnetic circuit, wherein:
the magnetic circuit includes a solenoid, an internal pole, and a magnet armature that cooperates with the solenoid and the internal pole;
there is a gap between the internal pole and the magnet armature; and
the magnetic circuit is configured to generate a controlled force action between the internal pole and the magnet armature when the electromagnetic actuator is activated with at least one of an activating current and an activating voltage;
producing a valve sleeve; and
arranging the electromagnetic actuator in the valve sleeve, wherein the valve sleeve is produced and arranged relative to the electromagnetic actuator so that the valve sleeve has (a) paramagnetic material properties in an area of the gap and (b) ferromagnetic material properties outside of the area of the gap.

25. The method of claim 24, wherein the producing of the valve sleeve includes annealing the valve sleeve outside the area of the gap and cooling the gap area during the annealing.

26. The method of claim 25, wherein the annealing is performed in a temperature range between 350° C. and 700° C.

27. The method of claim 25, wherein the cooling is performed using cooled nitrogen.
